(19) United States
(12) Patent Application Publication
(10) Pub. No.: US 2024/0018667 A1
(43) Pub. Date: Jan. 18, 2024

(54) METHOD OF MANUFACTURING CARBON FIBERS

(71) Applicant: The Regents of the University of Colorado, a Body Corporate, Denver, CO (US)

(72) Inventor: Spencer Dansereau, Boulder, CO (US)

(21) Appl. No.: 18/352,772

(22) Filed: Jul. 14, 2023

Related U.S. Application Data
(60) Provisional application No. 63/389,568, filed on Jul. 15, 2022.

(51) Int. Cl. C25B 1/135; C01B 32/158

(52) U.S. Cl. CPC C25B 1/135; C01B 32/158

(57) ABSTRACT

Provided herein is a method and apparatus for directly converting gaseous CO₂ into useful materials such as carbon fiber.

### CROSS-REFERENCE TO RELATED APPLICATION

This application claims priority to U.S. Provisional Patent Application Ser. No. 63/389,568 entitled “Method of Manufacturing Carbon Fibers,” filed Jul. 15, 2022, the disclosure of which is incorporated herein by reference in its entirety.

### STATEMENT REGARDING FEDERALLY SPONSORED RESEARCH

This invention was made with government support under 1743701 awarded by the National Science Foundation. The government has certain rights in the invention.

### BACKGROUND

The increasing amount of CO₂ in the atmosphere has various negative effects, from inconvenient to catastrophic. The most commonly referred-to effect from increasing CO₂ atmospheric levels are global (and local) warming of the planet. While this is often the most concerning and large-scale issue seen in the public eye, it is not the only side effect of increased CO₂ atmospheric levels. Of interest for this project (in addition to atmospheric CO₂ capture) is the massive amount of CO₂ that is absorbed into the world's oceans. This increase in CO₂ dissolved into the ocean water leads to formation of carbonic acid and overall acidification of the oceans, which can be detrimental to sea life.

The need for removing CO₂ from the atmosphere and oceans is critical, and if this process can be done in an economical manner by producing a high-strength, low-cost structural material component then the task becomes potentially feasible.

Additionally, the use of light-weight materials such as carbon fiber is finding increasing use in all industries, including the automotive, aerospace industries, and general construction, as a way to reduce the weight of manufactured products. A process that removes CO₂ from the air and converts it into valuable carbon fiber would be extremely desirable.

The present disclosure solves this unmet need.

### BRIEF SUMMARY OF THE INVENTION

In various aspects, a method of manufacturing a carbon material is provided. The method includes: contacting at least one molten salt in a molten salt electrolysis cell with a carbon dioxide-containing gas to form elemental carbon; and extruding the elemental carbon to form the carbon material. The molten salt electrolysis cell includes: an exterior casing; a cathode; and a screw-shaped anode having a threaded region and a tapered region ending in an anode tip.

In various aspects, an apparatus for manufacturing a carbon material is provided. The apparatus includes: a molten salt electrolysis cell comprising: an exterior casing; a cathode; and a screw-shaped anode having a threaded region and a tapering region ending in an anode tip.

### BRIEF DESCRIPTION OF THE FIGURES

The drawings illustrate generally, by way of example, but not by way of limitation, various embodiments of the present application.

FIG. 1 is a schematic of an apparatus for manufacturing carbon fiber, in accordance with various embodiments.

FIG. 2 is a cross-section of an apparatus for manufacturing carbon fiber, in accordance with various embodiments.

FIG. 3 is a cross-section of a portion an apparatus for manufacturing carbon fiber, in accordance with various embodiments.

FIG. 4 shows two views of an operating device, in accordance with various embodiments.

FIGS. 5A-5D show SEM images of carbon nanotube cathode product from electrolysis of 5 cm² Inconel 718 anode and brass cathode in 24-hr equilibrated Li₂CO₃ electrolyte housed in an alumina crucible. The size bars are 100 μm in both FIG. 5A and FIG. 5C, and are respectively 20 and 50 μm in FIG. 5B and FIG. 5D.

FIG. 5E illustrates that the cathode product in subsequent syntheses is grown by electrolysis with larger (25 cm²) brass and Inconel electrodes, in a rectangular 304 stainless steel case, rather than in a tall form alumina crucible.

FIGS. 6A-6F show various Li₂CO₃ mixed electrolyte electrolyses conducted with larger 25 cm² electrodes and containing an additional 27 g LiBO₂. SEM image of washed carbon nanotube product obtained from Na10 electrolysis (FIG. 6A) (10 μm scale bar SEM); from K20 electrolysis (FIG. 6B) (20 μm scale bar SEM); from Na20 electrolysis panel (FIG. 6C) (10 μm scale bar SEM) & (FIG. 6D) (80 μm scale bar SEM); Na50 electrolysis (FIG. 6E) (10 μm scale bar SEM); Na60 electrolysis (FIG. 6F) (50 μm scale bar SEM).

FIGS. 7A-7C depict a non-limiting illustration of an apparatus for manufacturing carbon fiber. FIG. 7A depicts an electrolytic cell as well as various suitable anode and cathode materials. FIG. 7B is an image of carbon nanotubes bearing a ZnO coating. FIG. 7C is an image of carbon nanotubes bearing without a coating.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Definitions

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “room temperature” as used herein refers to a temperature of about 15° C. to 28° C.

The term “standard temperature and pressure” as used herein refers to 20° C. and 101 kPa.

### Methods of Preparing Carbon Materials

In various embodiments, a method of manufacturing a carbon material is provided. The method includes contacting at least one molten salt in a molten salt electrolysis cell with carbon dioxide-containing gas to form elemental carbon; and extruding the elemental carbon to form the carbon material. In certain embodiments, the molten salt electrolysis cell includes an exterior casing. In certain embodiments, the molten salt electrolysis cell includes a cathode. In certain embodiments, the molten salt electrolysis cell includes a screw-shaped anode having a threaded region and a tapered region ending in an anode tip.

The carbon dioxide containing gas, in some embodiments, is a gas containing at least about 50, 60, 70, 80, 90, 91, 92, 93, 94, 95, 96, 97, 98, 99, 99.9, or 99.99% pure carbon dioxide (CO₂). The carbon dioxide-containing gas can contain inert gases, such as N₂, Ar, He, Kr, and the like. In various embodiments, the carbon dioxide-containing gas contains less than about 15, 10, 5, 4, 3, 2, 1, 0.5, 0.1, 0.05, or 0.001% oxygen or any other gas that undergoes or is capable of undergoing a chemical reaction under the conditions in the molten salt electrolytic cell. In various embodiments, the carbon dioxide-containing gas is at least 95% pure in terms of carbon dioxide.

The screw-shaped anode, in some embodiments, includes a constant-diameter threaded region and terminates in a tapered region. The tapered region can have a conical shape, with a base having the same diameter as the threaded region, and terminating in an anode tip. In some embodiments, the screw-shaped anode has an Archimedes screw thread profile such that it can act as a fluid pump for the molten salt when the screw-shaped anode is rotated. The screw-shaped anode can be made from a suitable electrically conductive material, including metals, metal alloys, and the like. Suitable metal alloys include alloys of any transition metal, including iron, nickel, copper, cobalt, chromium, molybdenum, tungsten, titanium, and the like. Metal alloys can also include non-metallic components such as carbon. In one embodiment, the screw-shaped anode is steel. In one embodiment, the screw-shaped anode is Inconel 718.

The cathode can be made from a suitable electrically conductive material, such as carbon, steel, brass, and the like.

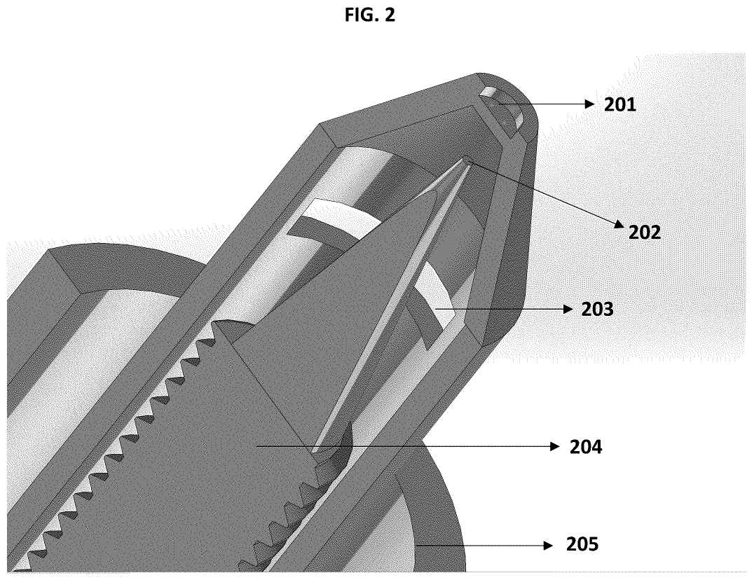

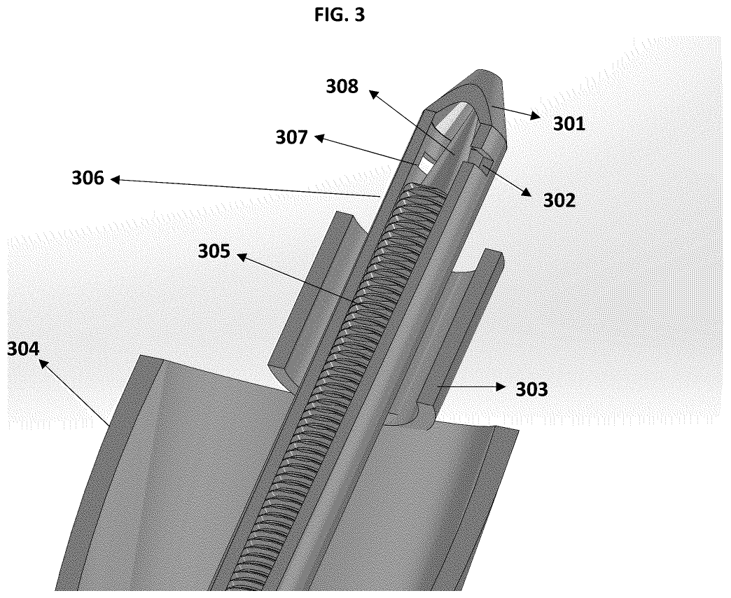

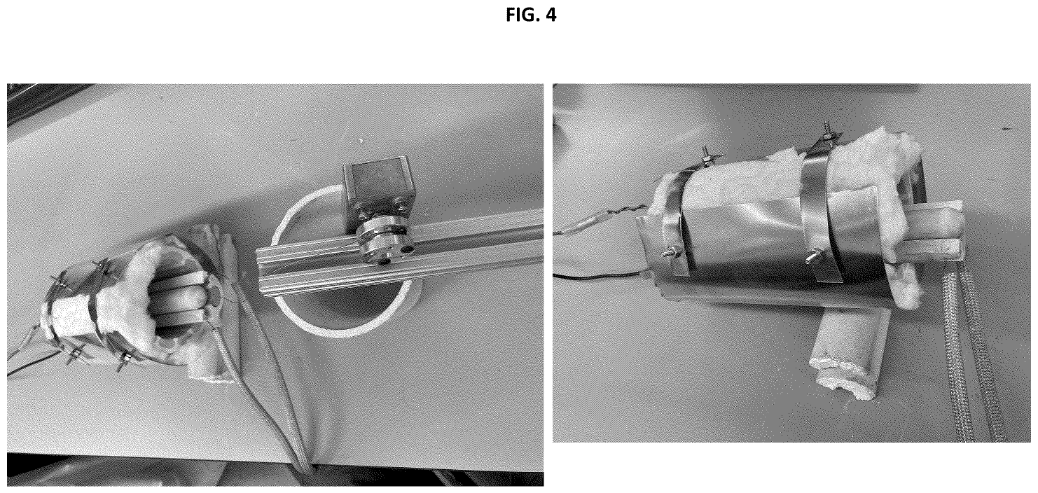

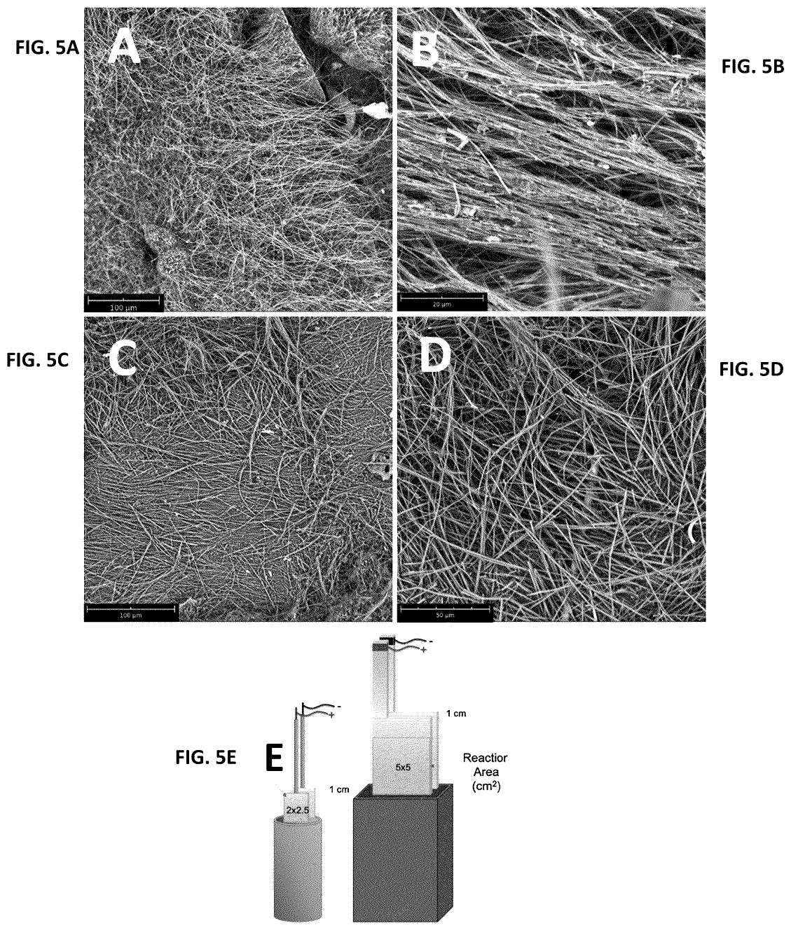

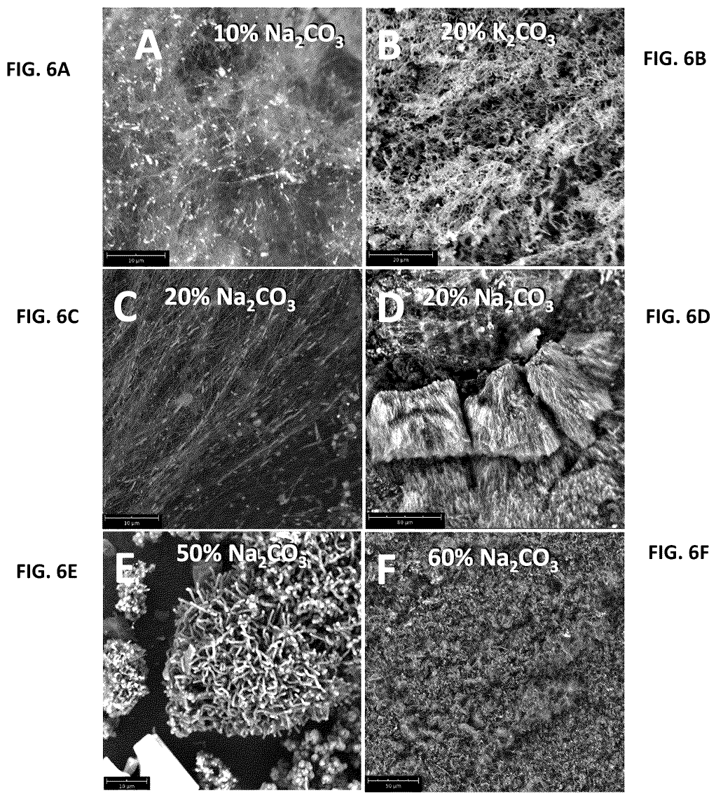

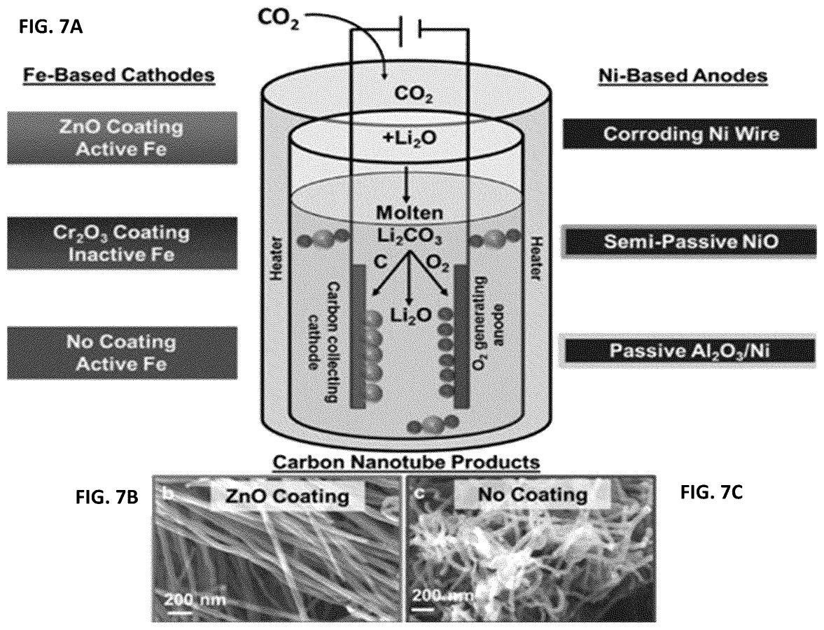

In various embodiments, the molten salt electrolysis cell further includes an extrusion aperture at one end of the exterior casing. The extrusion aperture can be about 1 μm to about 5 mm in diameter, or about 5 to about 25 μm in diameter, and permits extrusion of carbon material from the interior of the electrolysis cell. FIGS. 2 and 3 depict a suitable electrolysis cell, in various embodiments. In various embodiments, the extrusion aperture is 1, 2, 3, 4, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500 μm in diameter.

In various embodiments, the electrolysis cell has a gap region between the extrusion aperture and the anode tip. The distance between the extrusion aperture and the anode tip (the gap region), can be about 0.1 to about 10 mm, or about 0.1, 0.2, 0.3, 0.4, 0.5, 0.6, 0.7, 0.8, 0.9, 1, 2, 3, 4, 5, 6, 7, 8, 9, or about 10 mm.

In various embodiments, extruding includes drawing at least one carbon fiber through the extrusion aperture. In some embodiments, a seed strand can be inserted into the extrusion aperture, which provides a surface for carbon material to form on. In some embodiments, as the carbon material forms, and the seed strand is pulled/drawn away from the electrolysis cell, the carbon material is extruded from the electrolysis cell. The seed strand can be made from any suitable material on which the carbon can grow, including carbon fiber, metals, metal alloys such as steel, and the like. In various embodiments, the extruding further comprises rotating the at least one carbon fiber as the carbon fiber is drawn out of the extrusion aperture. In various embodiments, the at least one carbon fiber is rotated at an angular velocity of about 20 to about 500 revolutions per minute (rpm), or about 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or about 500 rpm.

In various embodiments, the carbon material forms in the gap region. In various embodiments, the carbon material only forms in the gap region. In various embodiments, the carbon material is elemental carbon. In various embodiments, the carbon material is carbon nanotubes. The carbon nanotubes can be single-walled, multi-walled, or a combination thereof.

In various embodiments, the screw-shaped anode rotates during formation of the elemental carbon. As noted herein, the screw-shaped anode can act as a pump to circulate the molten salt in the electrolysis cell. In various embodiments, the screw-shaped anode rotates at an angular velocity of about 20 to about 500 revolutions per minute (rpm), or about 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or about 500 rpm. The angular velocity can be constant during the entire extrusion process, or can be varied during certain intervals as necessary.

In various embodiments exterior casing is not electrically conductive. The exterior casing can be made of a suitable electrical insulator, such as a ceramic or metal oxide. In various embodiments, the exterior casing is alumina.

In various embodiments, the at least one molten salt comprises an alkali oxide, an alkali earth oxide, or a combination thereof. The operating temperature in the electrolysis cell can be about 700 to about 920° C., or about 720 to about 870° C. In various embodiments, one or more additives can be added to the molten salt. Suitable additives can include, for example, other metal salts such as transition metal oxides, sulfides, carbonates, and the like. In various embodiments, the additive can be any of the alkali earth carbonates, or an added boron, sulfur, or nitrogen additive. In some embodiments, the additive is LiBO₂, NaBO₂, KBO₂, alkali earth analogs thereof, and/or combinations thereof. One or more additives can be present individually or collectively in an amount of about 0.1 to about 20% (w/w) relative to the weight of the molten salt.

In various embodiments, the alkali oxide is selected from the group consisting of Li₂O, Na₂O, K₂O, and/or combinations thereof. In various embodiments, the at least one molten salt is a mixture of alkali metal oxides and alkali metal carbonates, such as Li₂CO₃, Na₂CO₃, K₂CO₃, and/or combinations thereof. In various embodiments, the alkali earth oxide is MgO, CaO, SrO, BaO, and/or combinations thereof. In various embodiments, the alkali earth carbonate is selected from the group consisting of MgCO₃, CaCO₃, SrCO₃, BaCO₃, and/or combinations thereof. In various embodiments, the molten salt is any combination of alkali oxides, alkali carbonates, alkali earth oxides, and alkali earth carbonates. In various embodiments, the molten salt includes only a single oxide/carbonate pair, for example all Li₂CO₃/Li₂O. In various embodiments, the molten salt is equilibrated for 1-24 hours prior to extrusion of carbon material, such for example 1, 2, 3, 4, 5, 6, 7, 8, 9, 10, 11, 12, 13, 14, 15, 16, 17, 18, 19, 20, 21, 22, 23, or 24 hours prior to extrusion of carbon material. The amount of alkali metal oxide can be about 5, 10, 15, 20, 25, 30, 35, 40, 45, or about 50% (w/w) of the molten salt. The amount of alkali metal carbonate can be about 5, 10, 15, 20, 25, 30, 35, 40, 45, or about 50% (w/w) of the molten salt. The amount of alkali earth metal oxide can be about 5, 10, 15, 20, 25, 30, 35, 40, 45, or about 50% (w/w) of the molten salt. The amount of alkali earth metal carbonate can be about 5, 10, 15, 20, 25, 30, 35, 40, 45, or about 50% (w/w) of the molten salt.

The electrochemical process that occurs in the molten salt electrolysis cell is, in some embodiments, according to reactions (1) and (2) as depicted in Scheme 1. In Scheme 1, M is an alkali metal as described herein. An analogous scheme exists for alkali earth oxides (M′O) and carbonates (M′CO₃), where M′ is an alkali earth metal.

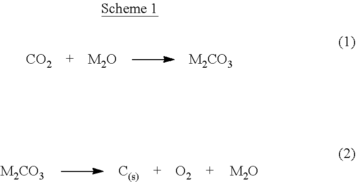

In various embodiments, an electric potential exists across the gap region to generate a current for the electrolysis process. In various embodiments, the electric potential is about 1.5 to about 2.5 V, or about 1.5, 1.6, 1.7, 1.8, 1.9, 2.0, 2.1, 2.2, 2.3, 2.4, or 2.5 V. In some embodiments, the electric potential generates a current density at the anode tip of about 50 to about 500 mA/cm². In some embodiments, the electric potential generates a current density at the anode tip of about 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or about 500 mA/cm². In various embodiments, the electrochemical process occurs in the gap region. In various embodiments, the rotation of the screw-shaped anode and resulting molten salt flow is started prior to the start of electrolysis. In various embodiments, the rotation of a starter (seed) fiber is started before the start of electrolysis.

In various embodiments, the extruded carbon material is carbon fiber. The carbon fiber, in some embodiments, has a diameter of about 2 μm to about 25 μm, or about 5 to about 15 μm, or about 2, 3, 4, 5, 6, 7, 8, 9, 10, 11, 12, 13, 14, 15, 16, 17, 18, 19, 20, 21, 22, 23, 24, or 25 μm. The extruded carbon fiber can have a constant diameter or can have regions of different diameter in the same strand. In various embodiments, the carbon atoms in the carbon fiber are sp³-bonded carbon atoms. In various embodiments, the carbon atoms in the carbon fiber form micro-scale graphene sheets in the length of the fiber.

### Apparatus for Preparing Carbon Materials

In various embodiments, an apparatus for manufacturing a carbon material is provided. The apparatus includes a molten salt electrolysis cell comprising at least one of the following: an exterior casing; a cathode; and a screw-shaped anode having a threaded region and a tapering region ending in an anode tip.

In various embodiments, the screw-shaped anode is in fluidic communication with a source of carbon dioxide. In various embodiments, the exterior casing is not electrically conductive. In various embodiments, the electrolysis cell further comprises an extrusion aperture at one end of the exterior casing. In various embodiments, the electrolysis cell includes a gap region between the extrusion aperture and the anode tip. In various embodiments, a means is provided for rotating the screw-shaped anode. Suitable means for rotating the screw-shaped anode include motors, and the like. In various embodiments, the exterior casing further includes a gas escape port and a molten salt overflow escape port. The gas escape port is suitable for venting oxygen gas formed from the electrolysis reaction and any other waste gasses that may be present in the electrolysis cell.

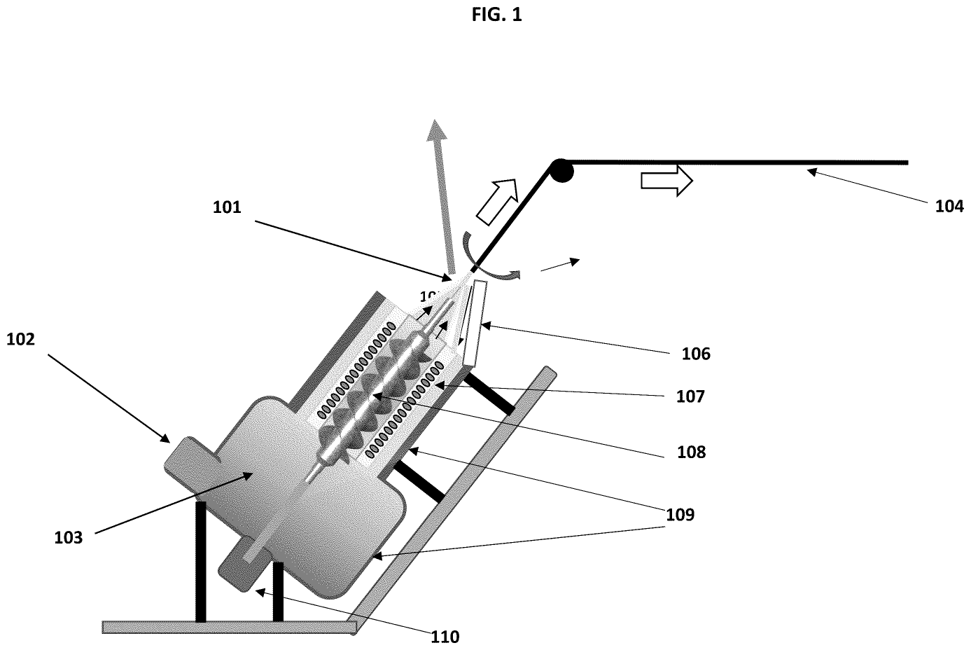

FIG. 1 is a schematic of an apparatus for manufacturing carbon fiber, in accordance with various embodiments. Referring to FIG. 1, carbonate salts undergo electrolysis in reaction zone (first reaction zone) 101, forming solid carbon, gaseous O₂, and oxide salts (which will then be returned to carbonates via CO₂ infiltrations); inlet 102 allows for introduction of CO₂ as well as inert/non-reactive gasses as described herein; oxide salts react with gaseous CO₂ to form carbonates in reaction zone (second reaction zone) 103; optionally, carbon fiber 104 is extruded out with C/Fe-based starter fiber (5 μm to 30 μm dia.), which can act as cathode. Carbon Fiber is laterally pulled out of solution, but it is also rotating concentrically in the extrusion holes to promote advantageous bonding directions (sp3, micro-scale graphene sheets in the length of the fiber) 105; salt overflow catch 106 for used and unused salt carrier, which can be re-directed to reservoir (not shown); furnace 107 (restive/electrical, fully insulated) is used for heating salts up to 600-870° C.; Archimedes screw 108, which can act as an anode, moves the molten salt to the reaction site; outside casing material 109 is composed of an insulating material, such as alumina (Al₂O₃), for both thermal and electrolysis non-reactivity reasons; motor 110 for rotating Archimedes screw 108. In some embodiments, the interface between the motor and furnace 107 is ceramic insulated, with a ceramic buffer plate in-between to allow the Archimedes screw itself to be electrified for electrolysis.

In certain embodiments, a screw-shaped anode having a threaded region and a tapered region ending in an anode tip includes an assembly as depicted in FIG. 2, although FIG. 2 should not be construed as being the only possible or workable arrangement for the screw-shaped anode having a threaded region and a tapered region ending in an anode tip. Referring to FIG. 2, the screw-shaped anode includes an extrusion aperture 201, anode tip 202, overflow port 203, lag bolt 204 for electrode and fluid movement, and overflow catch 205. In various embodiments, the lag bolt has a hollow center that allows for movement of molten salt.

In certain embodiments, a screw-shaped anode having a threaded region and a tapered region ending in an anode tip includes an assembly as depicted in FIG. 3, although FIG. 3 should not be construed as being the only possible or workable arrangement for the screw-shaped anode having a threaded region and a tapered region ending in an anode tip. Referring to FIG. 3, the screw-shaped anode includes extrusion nozzle 301, overflow escape port 302, primary overflow catch 303, alumina tubing (closed end) 304 for reservoir/secondary overflow catch, lag bolt/Archimedes screw 305, alumina tubing with integrated electrical heating elements 306, oxygen escape port 307, and electrode cone 308 that is part of an Archimedes screw 305.

### EXAMPLES

Various embodiments of the present application can be better understood by reference to the following Examples which are offered by way of illustration. The scope of the present application is not limited to the Examples given herein.

### Example 1

The salt precursor (NaO—100%) in powdered form (˜200 μm diameter average) is added into the reservoir and into the Archimedes screw tube. Carbon fiber starter fibers are inserted into the extruding nozzle such that the tip of the fiber is flush (within error on recessed fitment) with the interior of the nozzle near the Archimedes screw anode. Power to the furnace elements is then applied, with a ramp rate of 20° C. per minute, up until 870° C. is reached. The temperature is then held constant during the operational length of the experiment. The screw motor is then turned on, with an RPM of 100 (pre-calibrated to a given voltage), thereafter the rotation of the started fiber is initiated. Finally, the electrolysis power is turned on and the fiber extrusion motor is turned on. Parameters for these are 1.7V, 200 mA, and 10 RPM respectively.

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

### Enumerated Embodiments

The following enumerated embodiments are provided, the numbering of which is not to be construed as designating levels of importance:

Embodiment 1 provides a method of manufacturing a carbon material, the method comprising:
contacting at least one molten salt in a molten salt electrolysis cell with a carbon dioxide-containing gas to form elemental carbon; and
extruding the elemental carbon to form the carbon material,
wherein the molten salt electrolysis cell comprises:
   an exterior casing;
   a cathode; and
   a screw-shaped anode having a threaded region and a tapered region ending in an anode tip.

Embodiment 2 provides the method of embodiment 1, wherein the carbon dioxide-containing gas is at least 95% pure in terms of carbon dioxide.

Embodiment 3 provides the method of any one of embodiments 1-2, wherein the molten salt electrolysis cell further comprises an extrusion aperture at one end of the exterior casing.

Embodiment 4 provides the method of any one of embodiments 1-3, further comprising a gap region between the extrusion aperture and the anode tip.

Embodiment 5 provides the method of any one of embodiments 1-4, wherein the extruding step comprises drawing at least one carbon fiber through the extrusion aperture.

Embodiment 6 provides the method of any one of embodiments 1-5, wherein the carbon material forms in the gap region.

Embodiment 7 provides the method of any one of embodiments 1-6, wherein the screw-shaped anode rotates during formation of the elemental carbon.

Embodiment 8 provides the method of any one of embodiments 1-7, wherein the exterior casing is not electrically conductive.

Embodiment 9 provides the method of any one of embodiments 1-8, wherein the at least one molten salt comprises an alkali oxide, an alkali earth oxide, an alkali carbonate, an alkali earth oxide, or combinations thereof.

Embodiment 10 provides the method of any one of embodiments 1-9, wherein the alkali oxide comprises Li₂O, Na₂O, and/or K₂O.

Embodiment 11 provides the method of any one of embodiments 1-10, wherein the extruding step further comprises rotating the at least one carbon fiber as the carbon fiber is drawn out of the extrusion aperture.

Embodiment 12 provides the method of any one of embodiments 1-11, further comprising establishing an electric potential across the gap region.

Embodiment 13 provides an apparatus for manufacturing a carbon material, comprising:
a molten salt electrolysis cell comprising:
   an exterior casing;
   a cathode; and
   a screw-shaped anode having a threaded region and a tapering region ending in an anode tip.

Embodiment 14 provides the apparatus of embodiment 13, wherein the screw-shaped anode is in fluidic communication with a source of a carbon dioxide-containing gas.

Embodiment 15 provides the apparatus of any one of embodiments 13-14, wherein the exterior casing is not electrically conductive.

Embodiment 16 provides the apparatus of any one of embodiments 13-15, wherein the electrolysis cell further comprises an extrusion aperture at one end of the exterior casing.

Embodiment 17 provides the apparatus of any one of embodiments 13-16, further comprising a gap region between the extrusion aperture and the anode tip.

Embodiment 18 provides the apparatus of any one of embodiments 13-17, further comprising a means for rotating the screw-shaped anode.

Embodiment 19 provides the apparatus of any one of embodiments 13-18, wherein the exterior casing further comprises a gas escape port.

Embodiment 20 provides the apparatus of any one of embodiments 13-19, wherein the exterior casing further comprises a molten salt overflow escape port.

What is claimed is:

1. A method of manufacturing a carbon material, the method comprising:
contacting at least one molten salt in a molten salt electrolysis cell with a carbon dioxide-containing gas to form elemental carbon; and
extruding the elemental carbon to form the carbon material,
wherein the molten salt electrolysis cell comprises:
an exterior casing;
a cathode; and
a screw-shaped anode having a threaded region and a tapered region ending in an anode tip.

2. The method of claim 1, wherein the carbon dioxide-containing gas is at least 95% pure in terms of carbon dioxide.

3. The method of claim 1, wherein the molten salt electrolysis cell further comprises an extrusion aperture at one end of the exterior casing.

4. The method of claim 3, further comprising a gap region between the extrusion aperture and the anode tip.

5. The method of claim 3, wherein the extruding step comprises drawing at least one carbon fiber through the extrusion aperture.

6. The method of claim 4, wherein the carbon material forms in the gap region.

7. The method of claim 1, wherein the screw-shaped anode rotates during formation of the elemental carbon.

8. The method of claim 1, wherein the exterior casing is not electrically conductive.

9. The method of claim 1, wherein the at least one molten salt comprises an alkali oxide, an alkali earth oxide, an alkali carbonate, an alkali earth oxide, or combinations thereof.

10. The method of claim 9, wherein the alkali oxide comprises Li₂O, Na₂O, and/or K₂O.

11. The method of claim 5, wherein the extruding step further comprises rotating the at least one carbon fiber as the carbon fiber is drawn out of the extrusion aperture.

12. The method of claim 4, further comprising establishing an electric potential across the gap region.

13. An apparatus for manufacturing a carbon material, comprising:
a molten salt electrolysis cell comprising:
an exterior casing;
a cathode; and
a screw-shaped anode having a threaded region and a tapering region ending in an anode tip.

14. The apparatus of claim 13, wherein the screw-shaped anode is in fluidic communication with a source of a carbon dioxide-containing gas.

15. The apparatus of claim 13, wherein the exterior casing is not electrically conductive.

16. The apparatus of claim 13, wherein the electrolysis cell further comprises an extrusion aperture at one end of the exterior casing.

17. The apparatus of claim 16, further comprising a gap region between the extrusion aperture and the anode tip.

18. The apparatus of claim 13, further comprising a means for rotating the screw-shaped anode.

19. The apparatus of claim 13, wherein the exterior casing further comprises a gas escape port.

20. The apparatus of claim 13, wherein the exterior casing further comprises a molten salt overflow escape port.
